(19) United States
(12) Patent Application Publication
(10) Pub. No.: US 2021/0360917 A1
(43) Pub. Date: Nov. 25, 2021

(54) CUTICLE SUPPLEMENT FOR PLANT PRODUCTION

(71) Applicant: OREGON STATE UNIVERSITY, Corvallis, OR (US)

(72) Inventors: Clive KAISER, Corvallis, OR (US); Vaughn Martin WALTON, Corvallis, OR (US)

(21) Appl. No.: 16/978,611

(22) PCT Filed: Mar. 8, 2019
(86) PCT No.: PCT/US2019/021365

§ 371 Date: Sep. 4, 2020

Related U.S. Application Data
(60) Provisional application No. 62/640,514, filed on Mar. 8, 2018.

(51) Int. Cl. A01N 25/22; A01N 25/02; A01N 25/30; A01N 43/16; A01N 37/12; A01N 59/00

(52) U.S. Cl. CPC A01N 25/22; A01N 25/02; A01N 59/00; A01N 43/16; A01N 37/12; A01N 25/30

(57) ABSTRACT

Plant cuticle supplements and methods of their use are provided.

### CROSS-REFERENCE TO RELATED APPLICATION

This application claims the benefit of Provisional Application No. 62/640,514 filed Mar. 8, 2018, which is expressly incorporated herein by reference in its entirety.

### BACKGROUND OF THE INVENTION

The plant cuticle is an extracellular hydrophobic layer that covers the aerial epidermis of all land plants. The cuticle plays an important role in maintaining overall crop health and quality. The physiological role of the cuticle extends well beyond its primary function as a transpiration barrier, playing important roles in processes ranging from development to interaction with microbes. In some aspects, plant cuticle functions similarly to human skin, protecting the plant from dehydration as well as serving as a barrier against certain bacteria, fungi, pests, and environmental stresses (Yeats, T. H. and Rose, J. K. C. The Formation and Function of Plant Cuticles. Plant Physiology, September 2013, Vol. 163, pp. 5-20). By thickening the cuticle layer through the application of an exogenous product that can create a cuticle-like coating layer, the impact of plant stressors can be lessened, which can lead to increase in marketable yields and improving fruit quality. Several commercial products are available for this purpose. However, these products suffer from the common drawbacks, as they mostly work to prevent sunburn and do not provide complete plant protection. Some of them, if used too early in the growing season, can even induce sunburn. There is an existing need for a cuticle supplement that can provide protection from multiple stressors and is easy to apply, suitable for human consumption, and environmentally friendly.

### SUMMARY OF THE INVENTION

In one aspect, disclosed herein is a plant cuticle supplement, comprising: a carbohydrate skeleton component in an amount ranging from about 0.001% to about 20% water by weight; a swelling component in an amount ranging from about 0.001% to about 15% by weight; and a thickening component in an amount ranging from about 0.001% to about 15% by weight.

In some embodiments, the supplement is non-aqueous and/or further comprises a non-aqueous solvent component in an amount ranging from about 0.001% to about 40% by weight, for example, ethanol.

In some embodiments, the supplement disclosed herein further comprises a preservative component in an amount ranging from about 0.001% to about 40% by weight; an anti-oxidant component in an amount ranging from about 0.001% to about 15% by weight; a humectant component in an amount ranging from about 0.001% to about 15% by weight, an emollient component in an amount ranging from about 0.001% to about 25% by weight; an amphoteric surfactant component in an amount ranging from about 0.001% to about 15% by weight; an occlusive agent component in an amount ranging from about 0.001% to about 45% by weight; a fragrance component; a plasticizer component; a non-ionic surfactant; a film enhancing component in an amount ranging from about 0.001% to about 15% by weight; a bloom effect-providing component in an amount ranging from about 0.001% to about 15% by weight; an antifungal component; a spotted wing Drosophila (SWD) repelling component; or a combination thereof.

In some embodiments, the plant cuticle supplement comprises cellulose fiber, pectin, calcium bentonite, non-ionic surfactant, and amphoteric surfactant. In some embodiments, the antioxidant component of the plant cuticle supplement is Vitamin E, ascorbyl palmitate, or ascorbyl stearate, the humectant component is glycerol, the emollient component is safflower oil, the amphoteric surfactant component is lecithin. In other embodiments, the non-ionic surfactant is a silicone surfactant. In yet other embodiments, the film enhancing component is isopropyl myristate. In certain embodiments, the bloom effect-providing component is glycerol monosterate or borax.

In certain embodiments, the plant supplement comprises potassium sorbate and/or behenic acid.

In certain embodiments, upon application of an aqueous solution of the cuticle supplement disclosed herein to a plant or a plant part, the cuticle supplement forms an exogenous film thereon after drying of the aqueous solution, for example, with the thickness of the exogenous film being between about 0.1 um and about 150 um. In some embodiments, the thickness of the exogenous film is about 90 um, about 100 um, about 110 um, or about 120 um.

In some exemplary embodiments, the supplement comprises ethanol, lecithin, isopropyl myristate, safflower oil, Polysorbate 80, palm oil, glycerol monostearate, Vitamin E, Creafiber 90, pectin, calcium bentonite, and Sylcoat.

In another aspect, disclosed herein is an aqueous composition comprising the plant cuticle supplement of the disclosure in an amount ranging from about 0.1% to about 10% by volume or from about 0.1% to about 10% by weight.

In yet another aspect, provided herein is a method of treating a plant or a plant part, comprising: contacting the plant or a plant part with the aqueous composition of the disclosure, wherein upon drying of the composition an exogenous film is formed on the plant or a plant part. The plant or a plant part preferably comprises a fruit, flower, or vegetable. In some embodiments, contacting comprises spraying the aqueous composition onto the plant or plant part; dipping the plant or plant part into the aqueous composition, enrobing the plant or plant part with the aqueous composition, or a combination thereof. Preferably, the fruit, flower, or vegetable is attached to a plant or the fruit, flower, or vegetable is post-harvest.

In yet another aspect, disclosed herein is a method of reducing water consumption by a plant comprising contacting the plant with the aqueous compositions comprising plant cuticle supplement of the disclosure, wherein upon drying of the composition an exogenous film is formed on the plant thereby reducing water consumption by the plant, for example, an apple, cherry, or grape.

In some embodiments, water consumption is reduced by about 15%, by about 20%, by about 25%, by about 30%, or by about 50%.

Additionally, in another aspect, disclosed herein is a plant or a plant part, e.g., fruit or flower, comprising an exogenous film formed by contacting the plant or plant part with the aqueous composition disclosed herein, wherein the exogenous film forms thereon after drying of the aqueous composition. In some embodiments, the exogenous film does not substantially alter the taste of the plant or plant part as compared to a substantially equivalent plant or plant part lacking the exogenous film.

In some embodiments, the exogenous film is suitable for human consumption. The plant or plant part disclosed herein has increased post-harvest shelf life, increased cuticle strength, reduced pre-harvest susceptibility to fungal diseases, or a combination thereof as compared to a substantially equivalent plant in substantially equivalent conditions but lacking the exogenous film.

In certain embodiments, such plant part is fruit, e.g., cherry, blueberry, or grape, that has reduced cracking upon ripening as compared to a substantially equivalent fruit in grown in substantially equivalent conditions but lacking the exogenous film.

In some embodiments, the plant, e.g., apple, pear, cherry, wine grape, almond, peach, avocado, or citrus, has reduced water consumption as compared to a substantially equivalent plant in substantially equivalent conditions but lacking the exogenous film.

Additionally, provided herein is a method of reducing egg laying of D. suzukii in a plant, e.g., blueberry, comprising contacting the plant with the aqueous composition disclosed herein, wherein upon drying of the composition an exogenous film is formed on the plant thereby reducing egg laying of D. suzukii in the plant. In some embodiments, the egg laying is reduced by about 60%, about 70%, about 80%, about 90%, or about 95%. Preferably, the reduction of egg laying is found up to 30 days after contacting the plant with the aqueous composition of the disclosure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 demonstrates Drosophila suzukii blueberry exposure trials using 20 cm by 30 cm white organza mesh bags and covering fruit clusters containing 10-23 berries.

FIG. 2 shows effect of exemplary Cuticle Supplement compared to control treatments on Drosophila suzukii egg laying in fruit within mesh bags on eleven-year-old drip irrigated “Elliot” blueberry in Corvallis Oreg. during 2017. Bars with an asterisk indicate a significant reduction in egg laying.

FIG. 3 shows daily minimum and maximum temperatures and precipitation during the experimental period on “Elliott” blueberry in Corvallis, Oreg. during 2017. Arrows indicate the days during which field experiments were initiated.

FIG. 4 shows percentage fruit cracking of extremely cracking sensitive “Utah Giant” sweet cherries on the day of harvest in 2017 of the untreated control compared to 2 applications of 1% exemplary Cuticle Supplement (one at straw color and again 14 days later) in Milton Freewater, Oreg.

FIG. 5 shows bunch maturity of “Cabernet Sauvignon” (Clone 8) following treatment with exemplary Cuticle Supplement (4 applications of 0.5%) in spring and subjected to a 75% reduction in irrigation.

FIG. 6 shows bunch maturity of “Cabernet Sauvignon” (Clone 8) following treatment with exemplary Cuticle Supplement (4 applications of 0.5%) in spring and subjected to a 50% reduction in irrigation.

FIG. 7 shows bunch maturity of untreated “Cabernet Sauvignon” (Clone 8) subjected to 100% of normal irrigation.

FIG. 8 shows volumetric soil water content for “Cabernet Sauvignon” (Clone 8) irrigated with 1 gal per hour drippers.

FIG. 9 shows volumetric soil water content for “Cabernet Sauvignon” (Clone 8) sprayed 4 times with 0.75% exemplary Cuticle Supplement and irrigated with 0.75 gal per hour drippers.

FIG. 10 shows volumetric soil water content for “Cabernet Sauvignon” (Clone 8) sprayed 4 times with 0.50% exemplary Cuticle Supplement and irrigated with 0.75 gal per hour drippers

FIG. 11 depicts total berry weight (left axis) and average berry weight (right axis) of “Cabernet Sauvignon” (Clone 8) at harvest for vines sprayed 4 times with 0.5% exemplary Cuticle Supplement and subjected to drippers with either 0.5 gal per hour (right) or 0.75 gal per hour (middle) compared to an unsprayed control which received 1.0 gal per hour (left).

FIG. 12 is a graph of titratable Acidity of “Cabernet Sauvignon” (Clone 8) at harvest for vines sprayed 4 times with 0.5% exemplary Cuticle Supplement and subjected to drippers with either 0.5 gal per hour (left) or 0.75 gal per hour (middle) compared to an unsprayed control which received 1.0 gal per hour (right).

FIG. 13 is a graph of fruit size measurements of “Gala” apple fruit in Milton Freewater, Oreg. following 2 applications of exemplary Cuticle Supplement on Apr. 13, 2017 (pink stage of blossom) and again on May 19, 2017, as compared with untreated control.

FIG. 14 shows volumetric soil water content for unsprayed “Braeburn” apples irrigated twice weekly for 15 hours per week with 1.0 gal per hour drippers and 4 drippers per tree.

FIG. 15 shows volumetric soil water content for “Braeburn” apples sprayed twice with 1.0% exemplary Cuticle Supplement and irrigated twice weekly for 15 hours per week with 0.75 gal per hour drippers and 4 drippers per tree.

FIG. 16 shows volumetric soil water content for “Braeburn” apples sprayed twice with 1.0% exemplary Cuticle Supplement and irrigated twice weekly for 15 hours per week with 0.50 gal per hour drippers and 4 drippers per tree.

FIGS. 17A-17E show comparison of characteristics of Sweetheart′ cherries in 2018: control plants treated with 100% (no reduction) irrigation water (“Control”); plants treated with 100% (no reduction) irrigation water and Cuticle Supplement (“No Reduction”), plants treated with 13.1% reduction in irrigation water and Cuticle Supplement (“1× Reduction”), and plants treated with 31% reduction in irrigation water (“2× Reduction”). FIG. 17A shows average length of new shoot. FIG. 17B depicts fruit firmness at harvest. FIG. 17C shows fruit soluble solids at harvest.

FIG. 17D compares titratable acidity of the fruit at harvest. FIG. 17E shows skin color of the fruit at harvest. FIG. 17E shows pedicel color of ‘Sweetheart’ cherries at harvest.

FIG. 18 is a graph of soil moisture of Cabernet Sauvignon grapes for combined depths 0-400 mm in 2017 measured on dates indicated on the X axis.

FIG. 19 is a graph of soil moisture of Cabernet Sauvignon grapes for combined depths 0-400 mm in 2018 measured on dates indicated on the X axis.

### DETAILED DESCRIPTION OF THE INVENTION

Disclosed herein are novel cuticle supplements and methods of their use. The cuticle supplements are useful, among other things, for forming an exogenous film on plants and plant parts. The film can function to protect the plant from damage caused by weather conditions, infestation by organisms, as well as over ripening. Methods of making and using the film and plants and plant parts comprising the film are also provided.

The inventors discovered that when a component that acts as a carbon skeleton is used in combination with a swelling component and a thickening component, the resulting composition can form a film on a plant or a plant part with substantially increased thickness, surprisingly resulting in a cuticle supplement that combines several commercial advantages. The inventors found that when applied to plants or plant parts, the cuticle supplement forms an exogenous film that reduces water usage by plants by at least 25%. Additionally, the supplement (1) works as a superior fruit cracking prevention product; (2) acts as a sunburn protection product; (3) significantly reduces egg laying by Drosophila suzukii; (4) increases fruit size, e.g., in apples; (5) extends shelf life of fruit post-harvest by preventing scald and reducing moisture loss from the fruit; (6) acts as a barrier to fungal haustoria; and/or (7) supplements the vitamin content of fruit. When prepared without the use of water, the plant cuticle supplements have increased shelf life and minimized shipping weight.

Throughout the specification, the terms “plant cuticle supplement,” “plant cuticle “composition,” “cuticle supplement,” and “cuticle composition” are used interchangeably. In some embodiments, the plant cuticle supplements comprise a plurality of components, e.g., the compositions can be made from at least three, at least four, at least five, or at least six, at least seven, at least eight, or at least nine different components. Components are compounds or formulations of compounds that provide functionality to the composition, and when a given component is present in a composition, it can include one or more compounds that provide the functionality. For example, if a preservative component is included in a composition, the preservative component can include one or more compounds that act as a preservative and optionally one or more excipients.

The components used to make the compositions described herein include preservatives, swelling components, thickening components, carbohydrate skeleton components, surfactants, organic solvents, among others. In some instances, a particular compound, when added to the compositions, performs the function of more than one component. For instance, ethanol when used in a composition can increase the shelf life of the composition acting as a preservative and it can also solubilize ingredients during the preparation of the composition.

In certain embodiments, the plant cuticle supplements comprise a carbohydrate skeleton component, a swelling component; and a thickening component. In some embodiments, the plant cuticle supplement comprises a carbohydrate skeleton component in an amount ranging from about 0.001% to about 20% water by weight; a swelling component in an amount ranging from about 0.001% to about 15% by weight; and a thickening component in an amount ranging from about 0.001% to about 15% by weight. As used herein, unless otherwise noted, the term “about” means +/−5%, +/−10%, +/−15%, or +/−20%. In certain embodiments, the cuticle supplement is non-aqueous. In some embodiments, without wishing to be bound by theory, the cuticle supplement includes novel hydrophilic components, e.g., hemicellulose, pectin HM and LM that swell and bind with water, thus preventing the movement of additional water through the cuticle supplement.

In certain embodiments, the plant cuticle supplements disclosed herein comprise an organic solvent. In some embodiments, the plant cuticle supplements comprise a non-aqueous solvent component. The solvent can be present in any amount needed to prepare the compositions. In some embodiments, the solvent is present is an amount ranging from about 0.001% to about 40% by weight. In certain embodiments, the cuticle compositions comprise the organic solvent in an amount of about 5%, about 7.5%, about 10%, about 15%, or about 20% by weight. A particularly suitable solvent is ethanol, such as 200-proof ethanol. In some embodiments, ethanol is used to solubilize other components of the cuticle composition. In some embodiments, certain components of the cuticle compositions are suspended in ethanol. Ethanol or other suitable organic solvent can act a preservative component to prevent fungal and bacterial cultures from growing in the cuticle supplement.

The components suitable for inclusion into the cuticle supplements disclosed herein are described in detail below.

Preservative Component

In particular embodiments, the plant cuticle supplements disclosed herein comprise a preservative component. The preservative component is any compound or combination of compounds that can be used to increase the field or shelf life of the cuticle supplement or a plant or plant part comprising the film resulting from the application of the supplement, for example, fruits, flowers, and vegetables. The preservative component can be included in the cuticle composition in any concentration that is sufficient to increase the shelf life of the composition, the plant, or plant part treated with the composition, or the field life of the plant or plant part treated with the composition.

Preferably, the preservative component is present is an amount ranging from about 0.001% to about 40% by weight. Exemplary concentrations of preservative component in the cuticle compositions include from about 0.001% to about 40%, from about 0.01% to about 10%, from about 0.02% to about 9%, from about 0.05% to about 8%, from about 0.07% to about 7%, from about 0.10% to about 6%, and from about 0.15% to about 5% by weight.

Suitable preservative components include compounds of Table 1.

TABLE 1

| Exemplary preservative | Exemplary concentration |
|---|---|
| Ammonium caseinate | 0.001 to 10% |
| Ascorbyl palmitate | 0.001 to 10% |
| Ascorbyl stearate | 0.001 to 10% |
| Citrate salts (ammonium, calcium, sodium) | 0.0001 to 5% |
| Ethanol (200 proof) | 0.001 to 40% |
| L-cysteine (max = 0.5%) | 0.001 to 10% |
| Potassium sorbate | 0.001 to 10% |
| Vitamin E in soyabean oil (Tocopherol) | 0.0001 to 20% |
| Sodium alginate (+potassum sorbate) | 0.0001 to 15% |
| Tocotrienols | 0.0001 to 20% |

Surfactant Component

In particular embodiments, the plant cuticle supplements disclosed herein comprise a surfactant component, including non-ionic silicone surfactant components and amphoteric surfactant components. Surfactants are added to ensure the film does not bead up upon contact with plant or plant part, such as leaves or fruit. The preservative component can be included in the composition at any suitable concentration that is sufficient to achieve its function.

Preferably, surfactants are present is an amount ranging from about 0.001% to about 15% by weight. Exemplary concentrations of surfactants in the cuticle compositions include from about 0.001% to about 15%, from about 0.01% to about 10%, from about 0.02% to about 9%, from about 0.05% to about 8%, from about 0.07% to about 7%, from about 0.10% to about 6%, and from about 0.15% to about 5% by weight.

Suitable surfactant components include compounds of Table 2. In some embodiments, the cuticle supplements comprise both amphoteric and non-ionic surfactant components. Preferably, the amphoteric surfactant is lecithin. A particularly useful non-ionic component is a silicone surfactant, e.g., SylCOAT™.

TABLE 2

| Exemplary surfactant | Exemplary concentration |
|---|---|
| Lecithin | 0.001 to 15% |
| Polysorbate 80 | 0.001 to 15% |
| SylCOAT ™ | 0.001 to 15% |
| Diteric | 0.0001 to 15% |
| Egg yolk | 0.0001 to 15% |
| 1-Hexadecanaminium, N-(carboxymethyl)- | 0.0001 to 15% |
| N,N-dimethyl-, inner salt | |
| Lauryl betaine | 0.0001 to 15% |

Film Enhancing Component

In some embodiments, the plant cuticle supplements disclosed herein comprise a film enhancing component. The “film enhancing component” is any compound or mixture of compounds that enhances film spreading. Exemplary ingredients that can be used as film enhancing components include potassium silicate, calcium silicate, aluminum magnesium silicate, aluminum calcium silicate, magnesium silicate, aluminum sodium silicate, aluminum potassium silicate, aluminum sodium potassium silicate, magnesium trisilicate, silica, silicic acid and it salts, siloxanes, dimethicone copolyol, dimethicone copolyol fatty acid esters or ethers, silicone glycol copolymer, other water soluble silicates, isopropyl myristate, isopropyl palmitate, butyl stearate, diisopropyladipate, diacetyl adipate, dibutyl adipate, dioctyl adipate, glyceryl adipate, myristylmyristate, oleic acid, soybean oil, vegetable oil, ethyl oleate and combinations thereof.

The film enhancing component can be used at any concentration that allows the composition to spread and form a film. One of ordinary skill in the art will be able to determine the appropriate concentration of film enhancing component needed for a specific purpose. Exemplary concentrations of film enhancing components that can be used in the compositions include from about 0.01% to about 15%, from about 0.02% to about 9%, from about 0.05% to about 8%, from about 0.07% to about 7%, from about 0.10% to about 6%, and from about 0.15% to about 5% by weight. Table 3 provided below contains additional film enhancing components and exemplary concentrations.

TABLE 3

| Exemplary film enhancing component | Exemplary concentration |
|---|---|
| Calcium bentonite | 0.001 to 15% |
| Calcium Silicate | 0.001 to 2% |
| Isopropyl myristate | 0.001 to 15% |
| Amino acids (lysine, leucine, glycine, | 0.0001 to 5% |
| cysteine) | |

Antioxidant Component

In some embodiments, the plant cuticle supplements disclosed herein comprise an antioxidant component. The “antioxidant component” is a component that prevents or slows down oxidative damage to the compositions or plants and plant parts comprising film resulting from the application of the compositions. In some embodiment, antioxidants protect post-harvest fruit and vegetables from browning caused by oxidation. The antioxidants can be included at a concentration of from about 0.01 to about 1.0% by weight. One of ordinary skill in the art will be able to determine the appropriate concentration of antioxidant component needed for a specific purpose.

Exemplary antioxidants include EDTA, glutathione, alpha-tocopherol, tocopherols, vitamin E, vitamin E acetate, vitamin E palmitate, zinc glycinate, ascorbic acid and its salts of calcium, sodium, and potassium, ascorbyl palmitate, calcium citrate, BHA, BHT, guaiac extract, gallic acid and methyl, ethyl, propyl, dodecyl esters of gallic acid, phosphatidylcholine, propionic acid, sucrose, cyclodextrins, rosemary, and cysteine hydrochloride. Particularly useful antioxidants include vitamin E, ascorbyl palmitate, ascorbyl stearate, and combinations thereof. Table 4 provided below contains some additional exemplary antioxidants and their exemplary concentrations.

TABLE 4

| Exemplary antioxidant component | Exemplary concentration |
|---|---|
| Ascorbyl palmitate | 0.001 to 10% |
| Ascorbyl stearate | 0.001 to 10% |
| Beta-carotene | 0.0001 to 10% |
| Cysteine | 0.0001 to 10% |
| Ellagic acid | 0.001 to 5% |
| Gallic acid | 0.001 to 5% |
| Glutathione | 0.0001 to 5% |
| Glycine | 0.0001 to 5% |
| Leucine | 0.0001 to 5% |
| Lysine | 0.00001 to 10% |
| Oxalic acid | 0.0001 to 20% |
| Tocotrienols | 0.0001 to 15% |
| Ubiquinol | 0.0001 to 10% |
| Vitamin E in soybean oil (Tocopherol) | 0.0001 to 20% |

Humectant Component

In some embodiments, the plant cuticle supplements disclosed herein comprise a humectant component. A humectant is a component that helps spread film resulting from the application of the compositions and keeps the supplement pliable.

The humectants can be included at a concentration of from about 0.01 to about 25% by weight. Exemplary concentrations of humectant components that can be used in the compositions include from about 0.001% to about 25%, from 0.01% to about 20%, from about 0.01% to about 15%, from about 0.01% to about 10%, from about 0.05% to about 9%, from about 0.10% to about 7%, from about 0.10% to about 6%, and from about 0.15% to about 5% by weight. One of ordinary skill in the art will be able to determine the appropriate concentration of humectant component needed for a specific purpose.

Exemplary antioxidants include compounds of Table 5. A particularly suitable humectant for the preparation of the cuticle supplement compositions disclosed herein is glycerol.

TABLE 5

| Exemplary humectant component | Exemplary concentration |
|---|---|
| Agar | 0.001 to 5% |
| Alginic acid | 0.001 to 2% |
| Beeswax | 0.01 to 55% |
| Calcium chloride | 0.001 to 15% |
| Collagen | 0.01 to 25% |
| Diteric | 0.0001 to 25% |
| Gelatin | 0.001 to 15% |
| Glycerol | 0.001 to 25% |
| Hyaluronic acid | 0.001 to 20% |
| Lecithin | 0.001 to 25% |
| Polysorbate 20 | 0.001 to 20% |
| Sorbitol | 0.0001 to 15% |
| Pyrrolidone carbonic acid | 0.0001 to 25% |

Emollient Component

In some embodiments, the plant cuticle supplements disclosed herein comprise an emollient component. An emollient is a compound or mixture of compounds that can be added to facilitate spread of the film.

In some embodiments, the emollients can be included in the compositions disclosed herein at a concentration of from about 0.01 to about 45% by weight. Exemplary concentrations of emollient component include from about 0.001% to about 45%, from 0.01% to about 35%, from about 0.01% to about 31%, from about 1% to about 30%, from about 0.05% to about 15%, from about 0.10% to about 10%, from about 0.10% to about 6%, and from about 0.15% to about 5% by weight. One of ordinary skill in the art will be able to determine the appropriate concentration of emollient component needed for a specific purpose.

Exemplary emollients include compounds of Table 6. In some embodiments, particularly suitable emollients for the preparation of the cuticle supplements disclosed herein are safflower oil and palm oil.

TABLE 6

| Exemplary emollient component | Exemplary concentration |
|---|---|
| Beeswax | 0.001 to 45% |
| Borax | 0.0001 to 5% |
| Cetyl alcohol | 0.0001 to 15% |
| Cyclomethicone | 0.0001 to 15% |
| Dimethicone | 0.0001 to 15% |
| Fractionated coconut oil | 0.0001 to 40% |
| Glycerol | 0.0001 to 25% |
| Lanolin | 0.0001 to 15% |
| Palm oil | 0.0001 to 25% |
| Petrolatum | 0.0001 to 15% |
| Safflower oil | 0.0001 to 45% |
| Sunflower oil | 0.0001 to 45% |
| Tocopherol | 0.0001 to 15% |

Bloom Effect Component

In some embodiments, the plant cuticle supplements disclosed herein comprise bloom effect component. A bloom effect component is a compound or mixture of compounds that can be added to achieve or maintain the necessary bloom effect on a plant part, such as fruit. Inclusion of a bloom effect component is particularly advantageous for cuticle supplement compositions used in crops which require a bloom on the fruit, e.g., blueberry and wine grape.

In some embodiments, the bloom effect component can be included in the compositions disclosed herein at a concentration of from about 0.0001% to about 15% by weight. Exemplary concentrations of bloom effect component include from about 0.001% to about 15%, from 0.01% to about 15%, from about 0.01% to about 10%, from about 1% to about 15%, from about 0.05% to about 10%, from about 0.10% to about 5%, from about and from about 0.5% to about 5% by weight. One of ordinary skill in the art will be able to determine the appropriate concentration of bloom effect component needed for a specific purpose.

Exemplary bloom effect components include compounds of Table 7. In some embodiments, particularly suitable bloom effect component is glycerol monostearate.

TABLE 7

| Exemplary bloom effect component | Exemplary concentration |
|---|---|
| Borax | 0.0001 to 5% |
| Glycerol monostearate | 0.0001 to 15% |

Carbohydrate Skeleton Component

In some embodiments, the plant cuticle supplements disclosed herein comprise a carbohydrate skeleton component. A carbohydrate skeleton component is a compound or mixture of compounds that can be added to achieve or maintain a necessary cuticle-protecting film thickness, for example, about or greater than about 10 μm thick. In some embodiments, carbohydrate skeleton component comprises one or more cellulose esters. Preferred cellulose esters include inorganic esters, e.g., cellulose nitrate and cellulose sulfate, as well as cellulose esters from non-plant sources, e.g., hydroxymethyl cellulose from tunicates, microbes (e.g., Acetobacter xylinium), and algae (e.g., Cladophora). Furthermore, peptidoglycan (bacterial cell walls) and proteoglycan can be used to strengthen the exogenous film that forms on a plant or plant part after the application of the cuticle supplements disclosed herein. Additional useful carbohydrate skeleton components include cellulose propionate, fiber (both natural and synthetic), microfiber, microcrystalline cellulose, and regenerated cellulose (e.g. polyanionic cellulose).

In some embodiments, the carbohydrate skeleton component can be included in the compositions disclosed herein at a concentration of from about 0.0001% to about 20% by weight. Exemplary concentrations of carbohydrate skeleton component include from about 0.001% to about 20%, from 5% to about 15%, from about 0.01% to about 10%, from about 1% to about 15%, from about 0.05% to about 10%, from about 0.10% to about 5%, from about and from about 0.5% to about 5% by weight.

Exemplary carbohydrate skeleton components include compounds of Table 8. In some embodiments, particularly suitable carbohydrate skeleton components are selected from cellulose fibers of between about 0.1 um to about 150 um. In some embodiments, the carbohydrate skeleton component is cellulose fiber (for example, Creafiber 90 um, supplied by CreaFill Fibers Corp., 10200 Worton Rd, Chestertown, Md. 21620).

TABLE 8

| Exemplary Carbohydrate skeleton | |
|---|---|
| component | Exemplary concentration |
| Acrylate polymers | 0.0001 to 20% |
| Algal cellulose | 0.0001 to 20% |
| Arabinogalactan | 0.0001 to 20% |
| Baker's Yeast Glycan | 0.0001 to 20% |
| Cellulose acetate propionate | 0.0001 to 20% |
| Cellulose acetate butyrate | 0.0001 to 20% |
| Cellulose fiber (0.1 um to 150 um, | 0.0001 to 20% |
| e.g. Creafiber 90 um) | |
| Cellulose propionate | 0.0001 to 20% |
| Cellulose (tunicin) | 0.0001 to 20% |
| Ethyl acrylate | 0.0001 to 20% |
| Gellatin | 0.0001 to 20% |
| Hemicelulose | 0.0001 to 20% |
| Microbial cellulose | 0.0001 to 20% |
| Microcrystalline cellulose | 0.0001 to 20% |
| Microfibrillated cellulose | 0.0001 to 20% |
| Nitrocellulose | 0.0001 to 20% |
| Pectin | 0.0001 to 20% |
| Proteoglucan | 0.0001 to 20% |
| Peptidoglycan | 0.0001 to 20% |

Occlusive Agent Component

In some embodiments, the plant cuticle supplements disclosed herein comprise an occlusive agent component. An occlusive agent component is a compound or mixture of compounds helps create a hydrophobic barrier to prevent the movement of water.

In some embodiments, an occlusive component can comprise compounds selected from oils, silicones, waxes, and combinations thereof. Preferably, the occlusive agent component is palm oil.

In some embodiments, the occlusive agent component can be included in the compositions disclosed herein at a concentration of from about 0.0001% to about 45% by weight. Exemplary concentrations of occlusive agent component include from about 0.001% to about 45%, from 5% to about 15%, from about 0.01% to about 15%, from about 1% to about 15%, from about 0.05% to about 10%, or from about 0.10% to about 5% by weight. A non-inclusive list of useful occlusive agents and their exemplary concentrations is provided in Table 9.

TABLE 9

| Exemplary occlusive agent component | Exemplary concentration |
|---|---|
| Vegetable oils | 0.0001 to 45% |
| Waxes (e.g. palm oil, beeswax) | 0.0001 to 45% |
| Silicones | 0.0001 to 15% |

Thickening Agent Component

In some embodiments, the plant cuticle supplements disclosed herein comprise a thickening agent component. A thickening agent component is a compound or mixture of compounds that can be added to prevent the final composition from separating out during storage.

In certain embodiments, a thickening agent component can be included in the compositions disclosed herein at a concentration of from about 0.0001% to about 15% by weight. Exemplary concentrations of thickening agent component include from about 0.001% to about 15%, from 5% to about 15%, from about 0.01% to about 15%, from about 1% to about 15%, from about 0.05% to about 10%, or from about 0.10% to about 5% by weight.

In some embodiments, a thickening agent component can comprise compounds selected from the compounds of Table 10 and combinations thereof. Preferably, the occlusive agent component is calcium bentonite.

TABLE 10

| Exemplary thickening agent | Exemplary concentration |
|---|---|
| Albumin | 0.0001 to 15% |
| Attapulgite | 0.0001 to 15% |
| Arrowroot/tapioca | 0.0001 to 15% |
| Calcium bentonite | 0.0001 to 15% |
| Carrageenan (max 0.15%) | 0.0001 to 15% |
| Casein | 0.0001 to 15% |
| Collagen | 0.0001 to 15% |
| Diatomaceous earth | 0.0001 to 15% |
| Egg yolk | 0.0001 to 15% |
| Iota carrageenan | 0.0001 to 15% |
| Kappa carrageenan | 0.0001 to 15% |
| Kudzu powder | 0.0001 to 15% |
| Lambda carrageenan | 0.0001 to 15% |
| Locust bean gum (gluycomanan) | 0.0001 to 15% |
| Mucilage/sago starch | 0.0001 to 15% |
| Sodium bentonite | 0.0001 to 15% |
| Yoghurt | 0.0001 to 15% |

In some embodiments, the plant cuticle supplements disclosed herein comprise a fragrance component.

In certain embodiments, a fragrance component can be included in the compositions disclosed herein at a concentration of from about 0.0001% to about 20% by weight. Exemplary concentrations include from about 0.001% to about 15%, from 5% to about 15%, from about 0.01% to about 15%, from about 1% to about 15%, from about 0.05% to about 10%, or from about 0.10% to about 5% by weight. One of ordinary skill in the art will be able to determine the appropriate concentration of fragrance needed for a specific purpose.

In some embodiments, a fragrance component can comprise compounds selected from the compounds of Table 11 and combinations thereof.

TABLE 11

| Exemplary fragrance | Exemplary concentration |
|---|---|
| Butyl anthranilate | 0.0001 to 10% |
| Dimethyl anthranilate | 0.0001 to 20% |
| Eugenol | 0.0001 to 20% |
| Peppermint oil | 0.0001 to 20% |
| Thyme oil | 0.0001 to 20% |

In other embodiments, the compositions disclosed herein comprise a plasticizer component. Suitable exemplary plasticizers include compounds of Table 12 and mixtures thereof and can be added to the composition in the amount of 0.0001% to 25% by weight.

TABLE 12

| Exemplary plasticizers | Exemplary concentration |
|---|---|
| Beta-cyclodextrin | 0.0001 to 15% |
| Benzyl acetate | 0.0001 to 5% |
| Citric acid | 0.0001 to 15% |
| Epoxidized soybean oil | 0.001 to 25% |
| Glycerol triacetate | 0.0001 to 15% |
| Triethyl citrate | 0.0001 to 15% |

In some embodiments, other components that can be added to the cuticle supplement composition include behenic acid (0.0001% to 25%), for example, as a wax component for shine and disease prevention; lignin (0.0001% to 25%) for sunburn protection; ascorbyl palmitate (0.0001% to 20%), tocotrienols (0.0001% to 20%), and ammonium citrate (0.0001% to 20%) for prevention of postharvest browning reactions.

### Components for Control of Spotted Wing Drosophila (SWD)

In some embodiments, the cuticle supplement comprises one or more of components for control of spotted wing Drosophila (SWD).

Examples of such suitable components include thyme oil (0.0001 to 20%), thiamine (0.0001 to 20%), panthenol (0.0001 to 20%), and calcium propionate (0.0001 to 20%), for repulsion of spotted wing Drosophila (SWD). In some embodiments, the cuticle supplements include one or more synthetic sugar, for example, erythritol (0.0001 to 20%), or sorbitol (0.0001 to 20%), to create an attractant to SWD that contains low nutrient status. In other embodiments, the cuticle supplements include potassium sorbate (0.0001 to 30% range) for control of spotted wing Drosophila.

In some embodiments, the components of the compositions described herein are edible. In some embodiments, the components are selected from compounds and compositions that have a regulatory status of generally recognized as safe (GRAS) as provided by the United States Food and Drug Administration. In other embodiments, the components are listed on the Environment Protection Agency's 4A and 4B lists as being safe for the environment. In certain embodiments, each component of the cuticle supplement is GRAS. In other embodiments, each component of the cuticle supplement is on the Environment Protection Agency's 4A and 4B lists.

In some embodiments, the cuticle supplement comprises cellulose fiber, pectin, calcium bentonite, non-ionic surfactant, and amphoteric surfactant. In other embodiments, the plant cuticle supplement, comprises a carbohydrate skeleton component in an amount ranging from about 0.001% to about 20% water by weight; a swelling component in an amount ranging from about 0.001% to about 15% by weight; a thickening component in an amount ranging from about 0.001% to about 15% by weight, a non-aqueous solvent component in an amount ranging from about 0.001% to about 40% by weight, a preservative component in an amount ranging from about 0.001% to about 40% by weight, an anti-oxidant component in an amount ranging from about 0.001% to about 15% by weight, a humectant component in an amount ranging from about 0.001% to about 15% by weight, an emollient component in an amount ranging from about 0.001% to about 25% by weight, an amphoteric surfactant component in an amount ranging from about 0.001% to about 15% by weight, and an occlusive agent component in an amount ranging from about 0.001% to about 45% by weight. In other embodiments, the plant cuticle supplement further comprises one or more additional components selected from a fragrance component, a plasticizer component, a non-ionic surfactant, or a combination thereof.

In certain embodiments, the cuticle supplement further comprises a film enhancing component in an amount ranging from about 0.001% to about 15% by weight. In other embodiments, the supplement comprises a bloom effect-providing component in an amount ranging from about 0.001% to about 15% by weight.

In some embodiments, the cuticle supplement comprises ethanol, lecithin, isopropyl myristate, safflower oil, Polysorbate 80, palm oil, glycerol monostearate, Vitamin E, Creafiber 90, pectin, calcium bentonite, and Sylcoat™.

Methods of Use of the Cuticle Supplement Compositions

The disclosure also provides methods of use of the cuticle supplements and plants and plant parts that contain exogenous films that are created by contacting the plant or plant part with the compositions described herein. The term “exogenous,” as used herein, is intended to distinguish “exogenous” films from natural films or cuticles produced by plants.

The term “plant” as used herein refers to a whole plant including any root structures, vascular tissues, vegetative tissues, and reproductive tissues. A “plant part” includes any portion of the plant. For example, upon harvesting a tree, the tree separated from its roots becomes a plant part. Plant parts also include flowers, fruits, leaves, vegetables, stems, roots, branches, and combinations thereof that are less than the whole plant.

Application of the Cuticle Supplement Compositions

The cuticle compositions described herein can be applied to plants and plant parts using any method that allows the desired surface area to be contacted with the composition. The plant or plant part need not be covered completely with the composition to achieve the desired benefits. Preferably, the plant cuticle compositions are diluted with water to form an aqueous composition comprising the plant cuticle supplement in an amount ranging from about 0.1% to about 10%. The resulting aqueous formulation can be applied to a plant or plant part using any conventional methods. In certain embodiments, the plant or plant part is contacted with the aqueous composition described above, wherein upon drying of the composition an exogenous film is formed on the plant or a plant part. In some embodiments, the contacting comprises spraying the aqueous composition onto the plant or plant part, dipping the plant or plant part into the aqueous composition, enrobing the plant or plant part with the aqueous composition, or a combination thereof.

In some embodiments, the application of the cuticle supplement composition to the plant, plant part (e.g., fruits, vegetables, flowers, leaves, stems) results in formation of an exogenous film thereon. The term “film” as used herein refers to the creation of a layer on the plant or plant part. The layer does not need to be of uniform thickness or completely homogeneous in composition. Moreover, the film does not need to completely cover the object it is applied to. In some embodiments, the film covers only 10%, 20%, 30%, 40%, 50%, 60%, 70%, 80% or 90% of the surface area of the plant or plant part. In other examples, the thickness of the film varies by 10%, 20%, 30%, 40%, 50%, 60%, 70%, 80% or 90% over the object that is contacted with the film. In certain embodiments, these values vary by ±5%.

In some embodiments, the thickness of the exogenous film is between about 0.1 um and about 150 um. In other embodiments, the thickness of the exogenous film is about 90 um, about 100 um, about 110 um, or about 120 um.

Plants and Plant Parts Treated with the Cuticle Supplement Compositions

Additionally, disclosed herein are plants and plant parts, comprising an exogenous film formed by contacting the plant or plant part with the aqueous solution of the cuticle compositions, wherein the exogenous film forms thereon after drying of the aqueous composition. In some embodiments, the exogenous film does not substantially alter the taste of the plant or plant part as compared to a substantially equivalent plant or plant part lacking the exogenous film. In other embodiments, the plant part is fruit. Preferred fruits include cherry, blueberry, and grape. In certain embodiments, the fruit has reduced cracking upon ripening as compared to a substantially equivalent fruit grown in substantially equivalent conditions but lacking the exogenous film. In yet other embodiments, the plant or plant part has increased post-harvest shelf life, increased cuticle strength, or a combination thereof as compared to a substantially equivalent plant in substantially equivalent conditions but lacking the exogenous film.

In certain embodiments, the plant or plant part has reduced pre-harvest susceptibility to fungal diseases, such as powdery mildew in cherries, apples and wine grapes, botrytis in wine grapes, and apple scab in apples.

Water Consumption Reduction

In addition to the advantages described above, the compositions of the invention have other commercially important uses.

Provided herein is a method of reducing water consumption by a plant comprising contacting the plant with the aqueous composition comprising the plant cuticle supplement disclosed herein, wherein upon drying of the composition an exogenous film is formed on the plant thereby reducing water consumption by the plant. In some embodiments, the plant is apple, cherry, or grape. In certain embodiments, the water consumption is reduced by about 15%, by about 20%, by about 25%, by about 30%, or by about 50%. In some embodiments, the water consumption is reduced by greater than about 15%.

Drosophila Egg Laying Reduction

In other embodiments, the invention provides a method of reducing egg laying of D. suzukii in a plant comprising contacting the plant with the aqueous compositions comprising the cuticle supplement disclosed herein, wherein upon drying of the composition an exogenous film is formed on the plant thereby reducing egg laying of D. suzukii in the plant. In certain embodiments, the egg laying is reduced about 60%, about 70%, about 80%, about 90%, or about 95%. Preferably, the plant is blueberry. In some embodiments, the reduction of egg laying is found up to 30 days after contacting the plant with the aqueous composition.

While illustrative embodiments have been illustrated and described, it will be appreciated that various changes can be made therein without departing from the spirit and scope of the invention.

### EXAMPLES

### Example 1

### Preparation of Exemplary Cuticle Supplement

The preparation of a representative cuticle supplement of the invention is described below. The components and their amounts are summarized in Table 13.

TABLE 13
Representative cuticle supplement composition

| Component | Amount by wt % |
|---|---|
| Ethanol | 10.00 |
| Lecithin | 10.00 |
| Isopropyl myristate | 7.00 |
| Safflower oil | 16.00 |
| Polysorbate 80 | 9.00 |
| Glycerol | 5.00 |
| Palm oil | 15.00 |
| Glycerol monostearate | 5.00 |
| Vitamin E in soyabean oil | 2.00 |
| (Tocopherol) | |
| Creafiber 90 um | 5.00 |
| Pectin | 3.00 |
| Calcium bentonite | 5.00 |
| Sylcoat | 8.00 |
| TOTAL | 100.00 |

In a 200 mL beaker add 10 g of ethanol as a solvent. Add 7 g of isopropyl myristate (or myristal myristate). Add 9 g of polysorbate. Add 5 g of fractionated coconut oil (or glycerol). Add 2 g of tocopherol oil (Vitamin E). Add 16 g of safflower oil. Mix at 550 rpm and raise the temperature to 72 degrees C. Add 10 g of lecithin (or Deteric LP) and wait until lecithin is fully dissolved in solution. In a separate beaker, melt 15 g of soybean flakes (or palm oil) at 104 degrees C. Add the melted palm oil to other beaker and raise the temperature to 82 degrees C. Add 5 g of glycerol monostearate powder to the mixture and wait until everything has melted into solution. Then add 7 g of Creafiber 90 um and continue mixing. Add 3 g of pectin powder and wait for it to dissolve into solution. Turn the heat off and allow the mixture to cool while stirring at 550 rpm. Add the silicone surfactant (CAS #134180-76-0 or SylCOAT). Add 5 g of calcium bentonite. Once the solution has popped and cooled sufficiently, it may be decanted into containers before it solidifies at room temperature.

Application of the exemplary cuticle supplement composition disclosed above resulted in 25% reduction in water usage in apples, cherries, and wine grapes.

### Example 2

### Application of Cuticle Supplement

To apply the cuticle supplement to crops, 1 gal of the cuticle supplement composition described in Example 1 was diluted in 200 gal of water, and the solution was applied at 200 gal per acre at a tractor speed of 2 mph. Experimental field testing of the cuticle supplements was conducted under the direction of Oregon State University.

Where this product is applied to the plants and water applications are reduced by up to 25% there is no significant difference in soil moisture compared to industry controls where no cuticle supplement was applied. Application of the diluted composition reduces water usage by plants by at least 25%. Application of the diluted composition results in superior fruit cracking prevention. Application of the diluted composition provides sunburn protection. Application of the diluted composition results in significant reduction of egg laying by SWD. Application of the diluted composition increases fruit size in apples. Application of the diluted composition extends shelf life of fruit post-harvest by preventing scald and reducing moisture loss from the fruit. Application of the diluted composition provides a barrier to fungal haustoria. Application of the diluted composition supplements the vitamin content of fruit.

1) An application at pink stage of apple bloom results in significantly larger fruit (3 mm on average) than untreated control fruit. A subsequent application may be applied on apples in spring once the canopy has reached 50 cm in length. A third application may be done once the canopy has reached a length of 80 cm in length. The industry standard is to apply 20 gal of water per tree per day during the summer months. When the cuticle supplement is applied and only 15 gal per tree per day are applied, there are no significant differences in water extraction from the soil. Where the cuticle supplement is applied in conjunction with only 10 gal per tree per day, the soil profile dries out too much suggesting that the cuticle supplement is effective at reducing water usage in plants somewhere between 25 and 50%. The same is observed for wine grapes and cherries.

2) The cuticle supplement is a superior fruit cracking prevention product. ‘Utah Giant’ is the most susceptible cherry to rain-induced fruit cracking. In two previous studies using SureSeal™, its application did not significantly reduce fruit cracking of that cultivar. Two applications of the exemplary cuticle supplement after one initial rainfall event, significantly reduced further fruit cracking and at harvest fruit cracking was significantly less (35.7%) compared to the untreated check (47.8) (P< >3).

3) The formula of the cuticle supplement has been consistently refined to include ingredients that do not attract spotted wing Drosophila. Due to increased thickness of the fruit cuticle, the formulation described in Example 1 has consistently reduced egg laying of the spotted wing Drosophila by as much as 88.1% compared to the control. Comparatively, the most effective chemical alternative, malathion (an organophosphate) only reduces egg laying by about 50%.

### Example 3

### Oviposition Experiments

Laboratory Oviposition Experiments

Constant and uniform airflow was created within each of the arena using a vacuum at 1.5 L min⁻¹) from the base and through the upper portion of each of the respective containers. Reduction of egg laying using exemplary Cuticle Supplement was verified in double-choice behavioral experiments. Arenas were prepared using 2-L transparent Griffin-style graduated low-form plastic beakers (Nalgene, Rochester, N.Y.). For each beaker, nine ventilation holes (1 cm diameter) were cut along the circumference approximately 6 cm from the base. The holes were covered with fine white mesh in order to prevent D. suzukii individuals from escaping. The top of each beaker was drilled and connected to a 0.5 cm diameter plastic tube providing a vacuum, in order to create a constant and uniform air flow (1.5 L min⁻¹) within the containers. Beakers were placed upside down on a flat work surface covered by white paper sheets. Exemplary Cuticle Supplement was mixed at a 0.5% rate and treated fruit were dipped within the medium and allowed to dry for about 30 minutes before challenged by D. suzukii under sterile laboratory conditions at 22° C., 65% RH. Experiments were performed on blueberries, under controlled conditions. Deli cups (Dart Container Corporation, Mason, Mich.) were placed inside each arena, containing four fresh fruit in treated and control repetitions each. The control treatments only contained fruit with no exemplary Cuticle Supplement application. The fruit was exposed for about 30 minutes. 15 D. suzukii individuals, ten females and five males, were released into each arena and the number of eggs laid in each fruit was counted after 30 minutes. The experiment for each fruit type was replicated ten times.

Field Oviposition Experiments

Oviposition trials were conducted during 2017 and 2018 at the Lewis-Brown Farm at Oregon State University (44°33′13″N 123°13′07″W) in an organic eleven-year-old drip irrigated cv. Elliott blueberry field, and an organic sweetheart cherry orchard during 2018. Blueberry plants were spaced approximately 0.76 m apart within rows with 3.05 m between rows and were not treated with insecticides. The width and height of plants were approximately 1 m and 1.5 m, respectively. Two drip irrigation lines, one on either side of the blueberry plant, were placed under sawdust mulch cover within standard raised beds (Bryla, D. R., J. L. Gartung & Strik, B. C., 2011 Evaluation of irrigation methods for highbush blueberry—Growth and water requirements of young plants. Hort. Science 46 (1) 95-101) and provided irrigation at levels of 100% (255±5 mm H₂O per growing season), of the estimated crop evapotranspiration (ET_{c}) requirement (Bryla et al. 2011). Cherry trees were spaced ˜10 m apart, and irrigated similarly to blueberry.

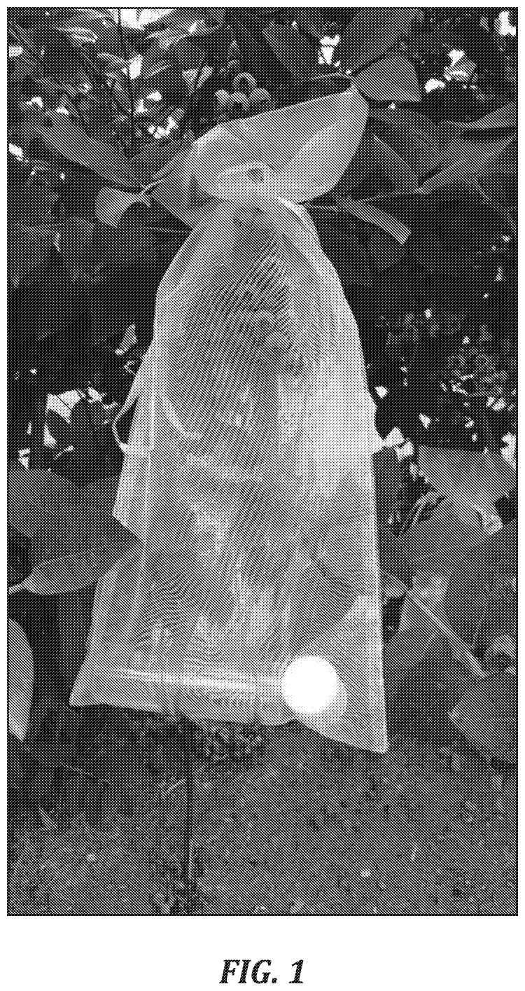

Here, trials were conducted by covering fruit clusters (10-23 berries) with 20 cm×30 cm white organza mesh bags (Uline, Pleasant Prairie, Wis.). All mesh bags were placed approximately 1 m apart on the north side of the bush within the shade of the canopy and 0.2 to 1.3 m above ground level (as shown in FIG. 1). Each mesh bag contained ten D. suzukii adults, five females and five males. Clusters were sprayed at the rate of 0.5% dilution rate on 12, 14 and 22 Aug. 2017 using an airblast backpack sprayer to the point just before drip off, and allowed to dry for approximately 30-45 minutes before covering the fruit clusters with mesh bags. For both years, fruit were challenged with D. suzukii one day after application. For the 22 Aug. 2017 applications, fruit were exposed to D. suzukii 6 and 13 days after the applications were done. Every trial date contained ten replicates for treated and control clusters each. All trials were started between 3 and 5 μm and were collected 72±2 hours later to determine the levels of oviposition on fruits for each of the treatments. All damaged berries were excluded when assessing the egg-laying levels in the laboratory under a dissecting microscope.

Firmtech fruit firmness data. Fruit firmness was determined by placing a minimum of 20 berries per replicate for each treatment onto a Firmtech berry measurement device in order to determine if the respective treatments resulted in increased fruit firmness.

Weather Data Weather data including temperature (° C.), humidity (%), and rainfall (mm) were obtained from the Corvallis, Oreg. Agrimet weather site (Oregon State University Hyslop Farm 44°38′03″ N 123°11′24″ W) (https://www.usbr.gov/pn/agrimet/agrimetmap/crvoda.html). In this way it was possible to verify daily the weather conditions during the field trials.

Statistical Analysis

Data from laboratory double-choice experiments and oviposition trials were analyzed, and the Tukey's test was applied to separate difference at α<0.05. Field trials data were analyzed using one-way or factorial ANOVA tests. Differences in volatile perception between Oregon and Italian D. suzukii were tested with the Mann-Whitney U-test (Mann and Whitney, 1947). All analyses were run using Statistica 64^{©} 12 (StatSoft Inc., Tulsa, Okla.; Hill and Lewicki, 2007).

Results of Laboratory Oviposition Experiments

Overall, the protectant resulted in a significant reduction in egg laying in blueberry compared to untreated control treatments under controlled laboratory conditions (mean reduction=54.97%, F_{1, 19}=15.24, P<0.001).

Results of Field Oviposition Trials

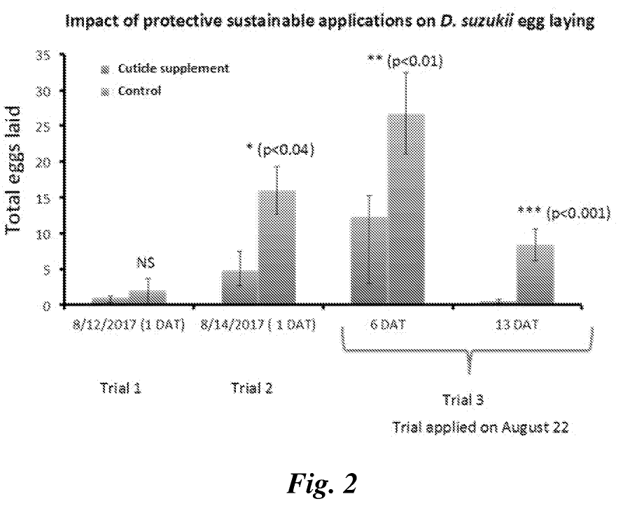

Field experiments using mesh bags to cover branches containing fruit indicated a consistent reduction of eggs laid using the Exemplary Cuticle Supplement matrix, with an overall reduction of eggs laid on fruits of 73.2% (F_{1, 51}=10.95, P=0.0017). The fruit exposed to D. suzukii in the mesh bag field experiments displayed a significant reduction of eggs laid on berries treated with Exemplary Cuticle Supplement on three of the four dates (Mean eggs in treated fruit=5.4±1.5, Mean eggs in control fruit=14.7±2.7, FIG. 2). The reduction of oviposition ranged from 50 to 93.4% during the D. suzukii exposure periods, which ranged from 72 to 96±2 hours. The reduction in egg laying at 6 and 13 days after application was 53.04 and 93.4% respectively. For the field trials looking at both fruit firmness and egg laying during 2017 and 2018 using this technology significantly increased fruit firmness by 10% in both trialed blueberry cultivars and the trialed cherry cultivar. This increase in fruit firmness was correlated with a 95% and an 87% (2017 and 2018 field data, respectively) decrease in SWD egg laying in blueberry and a 30% decrease in egg laying in cherry in Oregon trial (2018 field data); the effect continued up to 30 days after the initial application.

Weather Data

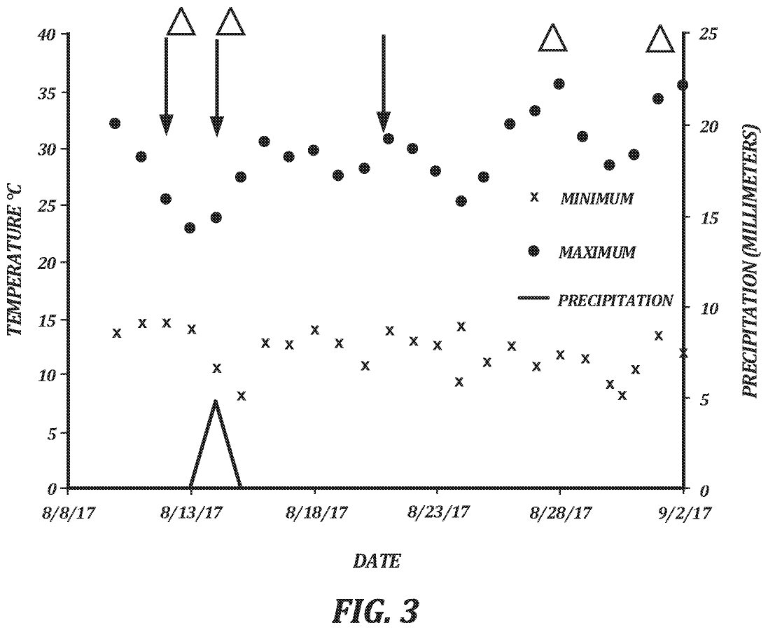

The temperature, humidity and precipitation from 12 to 31 August varied significantly during the respective trial events. The days during which the field experiments were performed are indicated (FIG. 3). The hottest day with the lowest humidity on which experiments were conducted occurred on 28 August, (Tₘₐₓ 35.3° C., mean 49.5% relative humidity) with no precipitation recorded. The coldest day with the highest humidity on which experiments were conducted occurred on 12 August, (Tₘₐₓ 22.8° C., a mean of 91.3% relative humidity). On 14 August 4.8 mm precipitation was recorded. It appears as if the varying weather conditions played a minimal role in the efficacy of the treatments.

### Example 4

Water Reduction Studies

Apples and wine grapes in the Walla Walla Valley and sweet cherries in The Dalles were treated with exemplary Cuticle Supplement in conjunction with reduced irrigation. In The Dalles, at Los Neubus Farm (45°35′53.0″N 121°14′08.8″W), ‘Skeena’/‘G6’ were selected. Treatments were laid out as a randomized complete block design with 4 treatments and 6 replications with 5 trees per rep. Treatments included: −0.61 gal per hour drippers (no exemplary Cuticle Supplement) as a check, 0.61 gal per hour plus 1% exemplary Cuticle Supplement, 0.53 gal per hour (13.1% reduction) plus 1% exemplary Cuticle Supplement and 0.42 gal per hour (31% reduction) plus 1% exemplary Cuticle Supplement. Treatment trees were sprayed with 1% exemplary Cuticle Supplement to the point of run-off on May 11, 2017 and May 24, 2017 and again at straw color on Jun. 10, 2017. Trees were irrigated daily for 4 hours from May, 2017 till September, 2017. Soil moisture was monitored weekly using a neutron probe by Jaq le Roux (www.irrinet.net). Fruit were harvested on Jul. 6, 2017 according to industry standards. On the day of harvest, the percentage cracked fruit for each tree was recorded. In addition, a sample of 50 fruit was harvested from each tree, and 25 fruit were analyzed for diameter, fruit firmness, pedicel-fruit retention force (PFRF) and total soluble solids (TSS). Fruit size (mm) and firmness (g/mm) were evaluated using a FirmTech 2 instrument from BioWorks of Wamego, Kans. Pedicel-fruit retention force (g) was measured with a Shimpo FGV-5x force gauge, Wilmington, N.C. Total soluble solids (TSS) (%) were measured with an Atago® handheld digital refractometer, Bellevue, Wash. The remaining 25 fruit were placed in cold storage at 2° C. for two weeks after which time they were removed from the cold room, held at room temperature for 14 hr to equilibrate, and subjected to the same analyses as on the day of harvest. Results were analyzed using Genstat® 19^{th} Edition for General Analysis of Variance (ANOVA) and means were tested against each other using a Tukey test. Results were considered statistically significant only if P<0.05.

In Milton Freewater, 18-year-old ‘Utah Giant’ sweet cherry trees were sprayed with 1% exemplary Cuticle Supplement at straw color and again 2 weeks later. ‘Utah Giant’ is one of the most susceptible cherry cultivars and previous testing of all other biofilms developed by inventor were unable to negate fruit cracking in this particular cultivar. On the day of harvest, 100 fruits per tree were harvested evaluated for fruit cracking. From that sample 25 uncracked fruit were evaluated on the day of harvest for fruit size, firmness, stem pull force, total soluble solids (TSS) and titratable acidity (TA). An additional 25 uncracked fruit were stored in regular atmosphere storage for 14 days at 4° C. in the afternoon of the 14th day, all fruit were removed from the cold store allowed to equilibrate overnight at room temperature (22° C.) and then evaluated as on the day of harvest. Results were analyzed using Genstat® 19^{th} Edition for General Analysis of Variance (ANOVA) and means were tested against each other using a Tukey test. Results were considered statistically significant only if P<0.05.

In Milton Freewater, 15-year-old Joburn ‘Braeburn’/‘106’ apples on an 18×12 feet spacing in a commercial block at Stadleman's Apple Blossom Orchard (45°58′13.0″N 118°25′15.4″W) were selected for a 3×6 factorial design with 3 treatments and 6 replications with 5 whole trees per replicate. Each tree had 4 drippers per tree placed 3 feet from the trunk of the tree in each quadrant. Treatments included: —an untreated check with drippers emitting 1.0 gal per hour; drippers emitting 0.75 gal per hour plus two applications of 1% exemplary Cuticle Supplement, and drippers emitting 0.5 gal per hour plus 2 applications of 1% exemplary Cuticle Supplement. Exemplary Cuticle Supplement was sprayed to the point of runoff using a commercial Turbomist P30 sprayer at a fan speed of 440 rpm and tractor speed of 2.0 mph at a rate of 200 gal per acre on May 19, 2017 and again on 7/79/17. Tractor speed was 2.0 mph. Tree were irrigated twice weekly for 5 hours on Mondays and 4 hours on Thursday. Due to a long, wet spring, irrigation only started on Jul. 1, 2017 and stopped on Sep. 25, 2017. Soil moisture measurements were taken weekly from Jun. 21, 2017 till Aug. 10, 2017. Individual trees were rated for crop load at harvest (on scale of 1 to 5) where 1 was no yield and 5 was high yield. Eight fruits were randomly picked from each tree between 1.5 and 1.8 m off the ground and taken back to the laboratory for quantitative evaluation. Fruit size, total soluble solids (TSS) (%) and acidity were measured using an Atago® held-held refractometer. Results were analyzed using Genstat® 19^{th} Edition for General Analysis of Variance (ANOVA) and means were tested against each other using a Tukey test. Results were considered statistically significant only if P<0.05.

In Milton-Freewater, Oreg. at Seven Hills Vineyard (45°56′51.80″ 118°26′58.86″W) in a block of ‘Cabernet Sauvignon’ (Clone 8) on own-roots, a 3×5 factorial with 5 reps per treatment and 5 whole vines per rep was laid out. Each vine had one dripper per vine spaced approximately 6 inches away from the trunk. The untreated check had drippers emitting 1 gal per hour and the other two treatments received 0.75 gal per hour or 0.5 gal per hour. Both the reduced treatments received 4 applications of 0.5% exemplary Cuticle Supplement sprayed to the point of runoff on May 23, 2017, Jun. 6, 2017, Jun. 20, 2017 and Jul. 5, 2017. Based on soil water content and vine water potential, deficit irrigation was practiced on the untreated check and vines received irrigation only when necessary (Table 14).

TABLE 14
Dates and number of hours of irrigation applied to
‘Cabernet Sauvignon’ grapes at Seven Hills
Vineyard, Milton Freewater, OR in 2017.

| Date | No. hours of irrigation |
|---|---|
| 4/26 | 2 |
| 5/5 | 9.5 |
| 5/30 | 9 |
| 7/7 | 9 |
| 7/20 | 6 |
| 7/24 | 6 |
| 7/31 | 6 |
| 8/5 | 6 |
| 8/11 | 11.5 |
| 8/17 | 12 |
| 8/24 | 10 |
| TOTAL | 87 |

Soil moisture measurements were taken weekly from Jun. 21, 2017 until Aug. 10, 2017. At harvest individual vines were harvested and weights per vine were recorded. Grapes were transported to the Washington State University Chateau St. Michelle Wine Science Center, where postharvest quality of grapes including average berry size, berry color, TSS, acidity, pH and flavonoid and phenolic panels run for each rep. Results were analyzed using Genstat® 19^{th} Edition for General Analysis of Variance (ANOVA) and means were tested against each other using a Tukey test. Results were considered statistically significant only if P<0.05.

Results

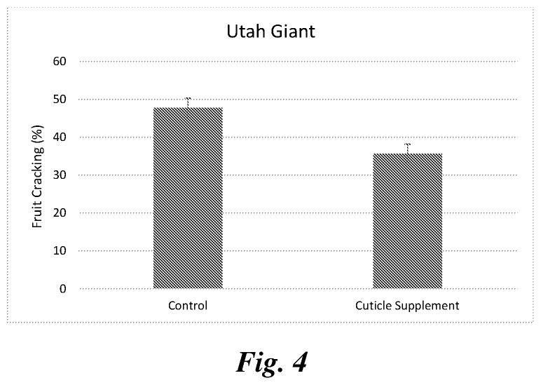

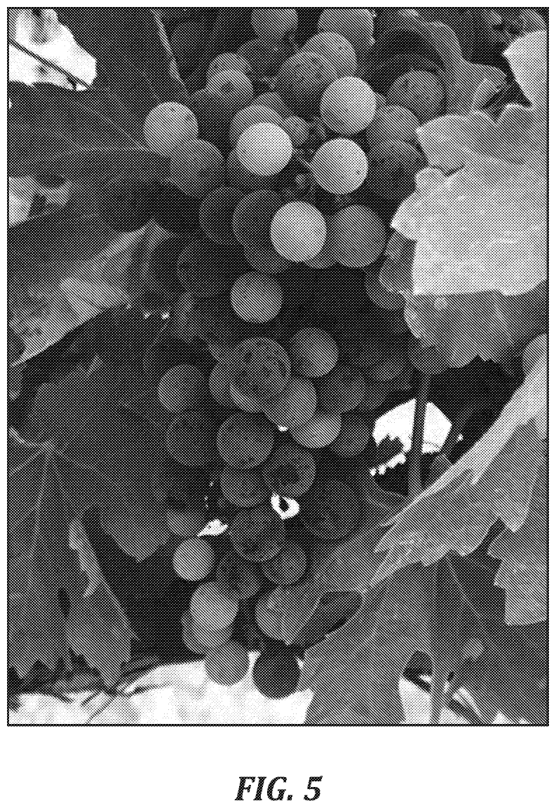

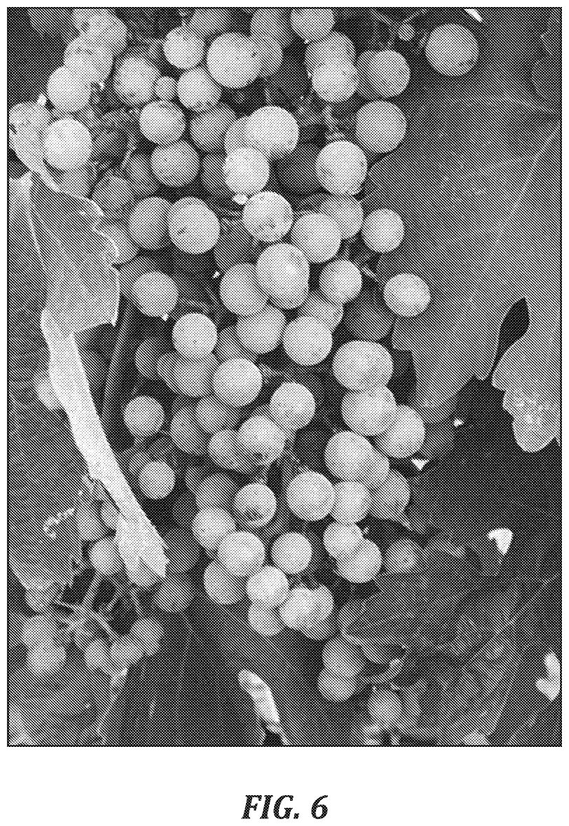

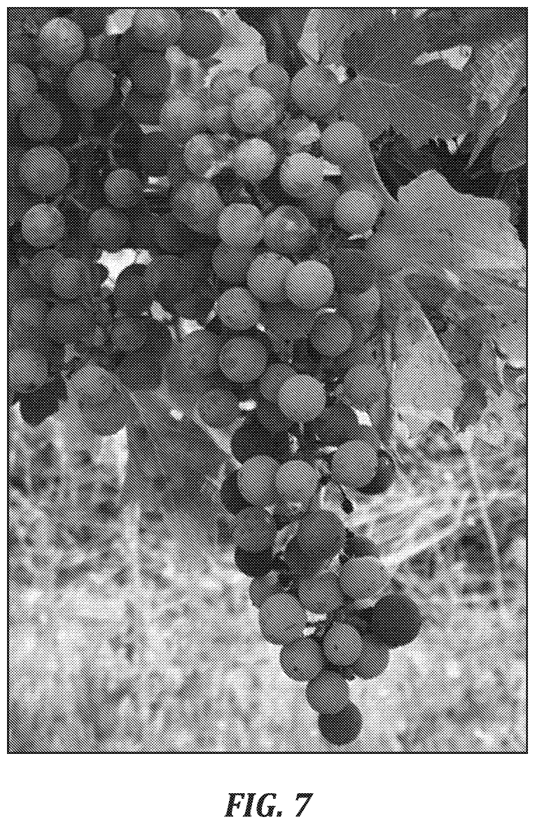

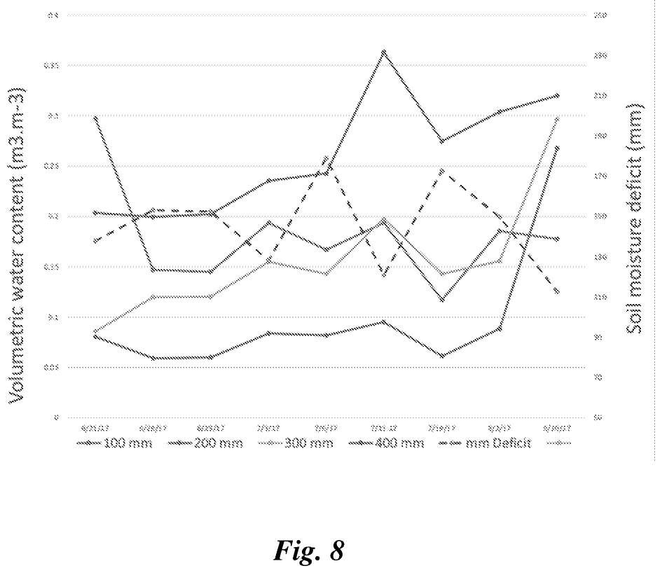

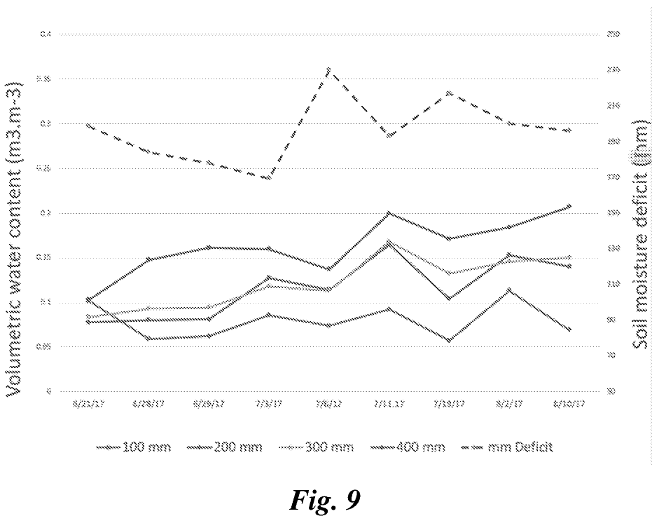

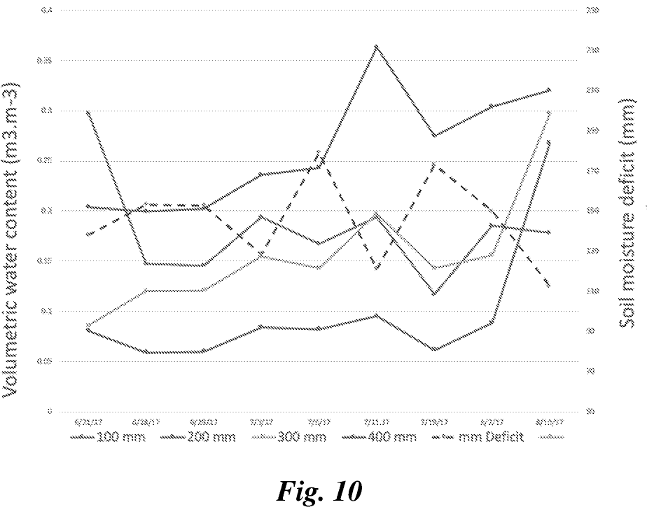

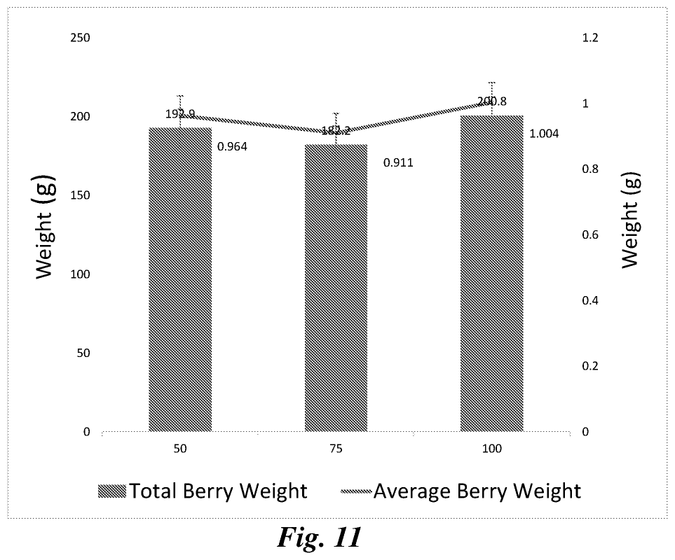

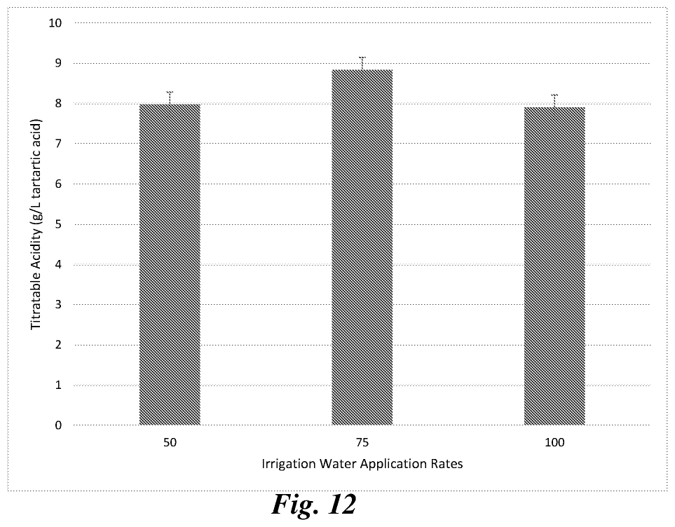

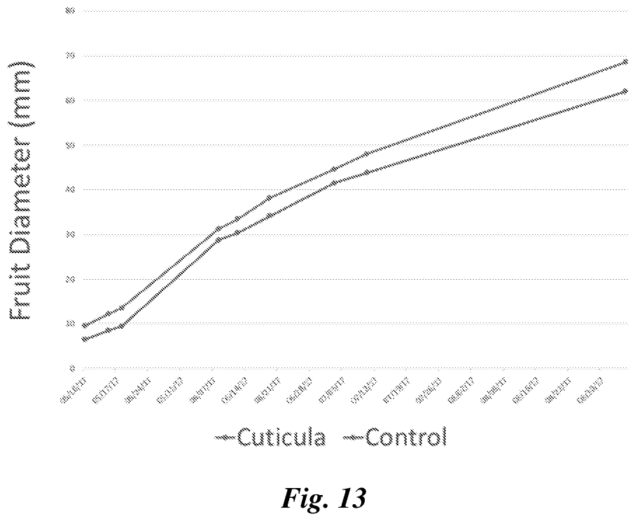

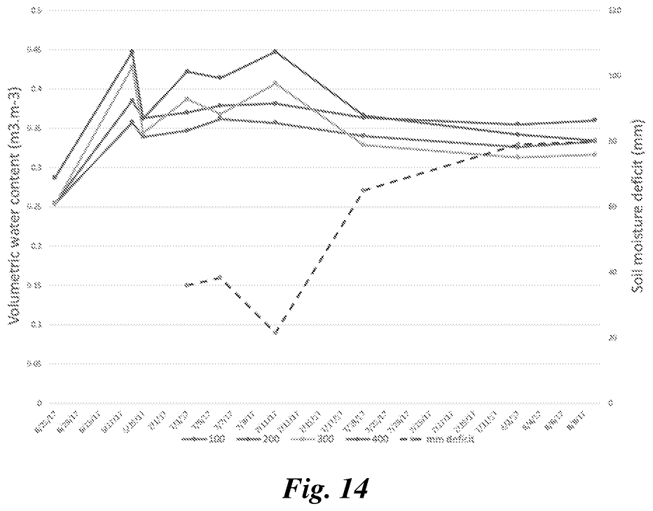

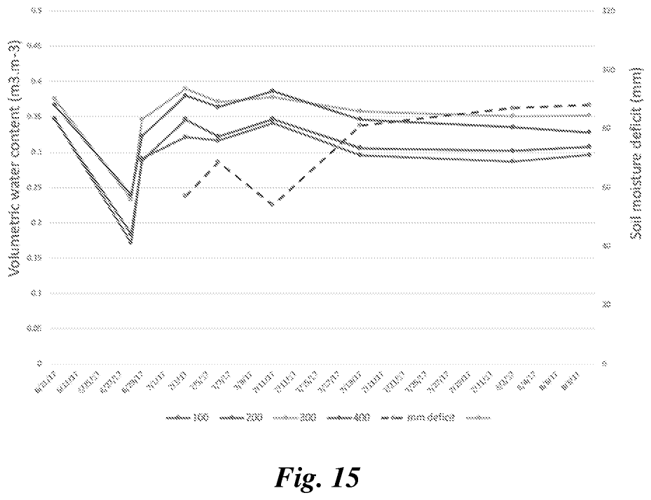

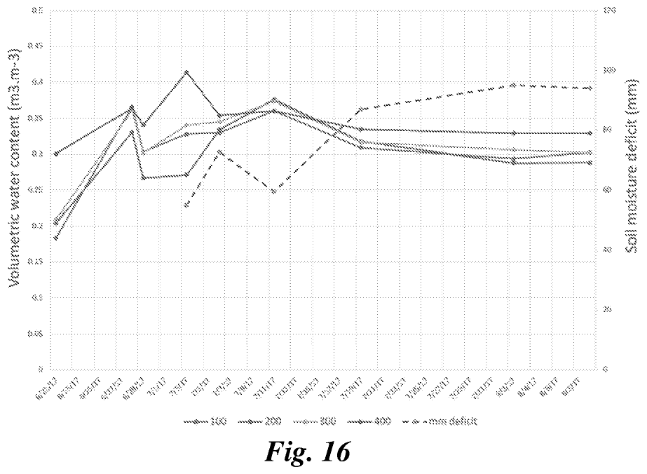

In 2017, in the Dalles, Oreg. drip irrigation reductions of 13.1% and 31% in combination with 3 applications of 1% exemplary Cuticle Supplement did not result in any negative findings where yield, fruit quality or storability were concerned when compared to trees that received 100% irrigation according to industry standard irrigation practices. No cracking was observed in any of the fruit as no significant rainfall events occurred. In Milton Freewater, Oreg., ‘Utah Giant’ fruit cracked as a result of two significant rainfall events during harvest in 2017. Trees sprayed twice with 1% exemplary Cuticle Supplement protected this highly susceptible-to-cracking fruit and resulted in a significant reduction from of 47.8% cracking (in the untreated control) compared to 35.7% cracking for the exemplary Cuticle Supplement treatment (FIG. 4). This result is truly significant as no other biofilm developed by the inventor before was able to reduce fruit cracking in ‘Utah Giant’. There were no other significant differences in fruit size or quality between the trees sprayed with exemplary Cuticle Supplement or not.

Where grapes in Milton-Freewater were concerned, 4 applications of 0.5% Exemplary Cuticle Supplement resulted in changes to timing of veraison. Compared to the untreated check in conjunction with 1.0 gal per hour drippers (FIG. 5) vines which received 75% less irrigation water in conjunction with 4 applications of 0.5% exemplary Cuticle Supplement (FIG. 6), veraison was accelerated by approximately 7 days. In contrast, vines which received 50% less irrigation water in conjunction with 4 applications of 0.5% exemplary Cuticle Supplement resulted in veraison being delayed by 3 days (FIG. 7) compared to the untreated check (FIG. 5). At harvest however, there were no significant differences in yield per vine, average berry size (FIG. 11), color, TSS or pH. Interestingly however, titratable acidity (FIG. 10) of grapes subjected to 75% less irrigation water had significantly higher titratable acidity that those subjected to 50% less water or the untreated check. Where soil moisture content in the top 40 cm of the soil profile was concerned, the check (FIG. 8), which received no exemplary Cuticle Supplement and 100% or regular deficit irrigation was similar to that of vines, which received 75% less water in conjunction with 4 applications of 0.5% exemplary Cuticle Supplement (FIG. 9) Vines which received 50% less water in conjunction with 4 applications of exemplary Cuticle Supplement (FIG. 10) showed signs of drying out at 40 cm in the soil profile. Despite this, these vines set and retained comparable yield and resulted similar fruit quality to the untreated check. The results to date indicate that a 25% reduction in water is easily achievable when applied in conjunction with 4 applications of 0.5% exemplary Cuticle Supplement in wine grapes.

Where apples were concerned, Gale ‘Gala’ apples sprayed twice with exemplary Cuticle Supplement resulted in 10% larger apples at harvest. This was something that was observed within two weeks after application and continued through harvest (FIG. 13). This is noteworthy since ‘Gala’ apples are traditionally small and a 10% increase in fruit size translates to more than 10% increase in packout of extra fancy fruit especially since the class center for Count 88 (cutoff for highest quality fruit) falls in the upper portion of normal distribution for fruit size on any one tree. Where the irrigation study on ‘Braeburn’ apples was concerned, there were no significant differences in estimated yield per tree, color or internal fruit quality characteristics. Fruit were on average 8.5% and 5.6% larger on those trees sprayed with exemplary Cuticle Supplement and subject to 75% and 50% less irrigation water. Neither TSS nor titratable acidity were significantly different between apples sprayed with exemplary Cuticle Supplement or the untreated check. Consequently, it is possible to produce ‘Braeburn’ apples with up to up to 50% less irrigation water under typical dry summer conditions experienced in the Pacific Northwest when sprayed with 1% exemplary Cuticle Supplement. Furthermore, a gain of up to 10% increase in fruit size was observed without affecting yield or internal quality. Finally, soil moisture content was not adversely affected for apples under drip irrigation in the top 40 cm of soil (FIGS. 14-16) when plants were sprayed with 1% exemplary Cuticle Supplement despite reductions of up to 50% in irrigation water.

In 2018, water reductions of 25% were achieved in wine grapes and a 15% water reduction was achieved in sweet cherries.

For grapes, actual yields were not significantly different as a result of reducing irrigation water by 25% in conjunction with four applications of 0.5% of exemplary Cuticle Supplement. The 50% reduction in irrigation water however, resulted in a slight but significant reduction in yield. Furthermore, changes in average internal fruit quality parameters including TSS, acidity, were also non-significant. Berry size was also unaffected by the different irrigation treatments in conjunction with the application of 1% exemplary Cuticle Supplement.

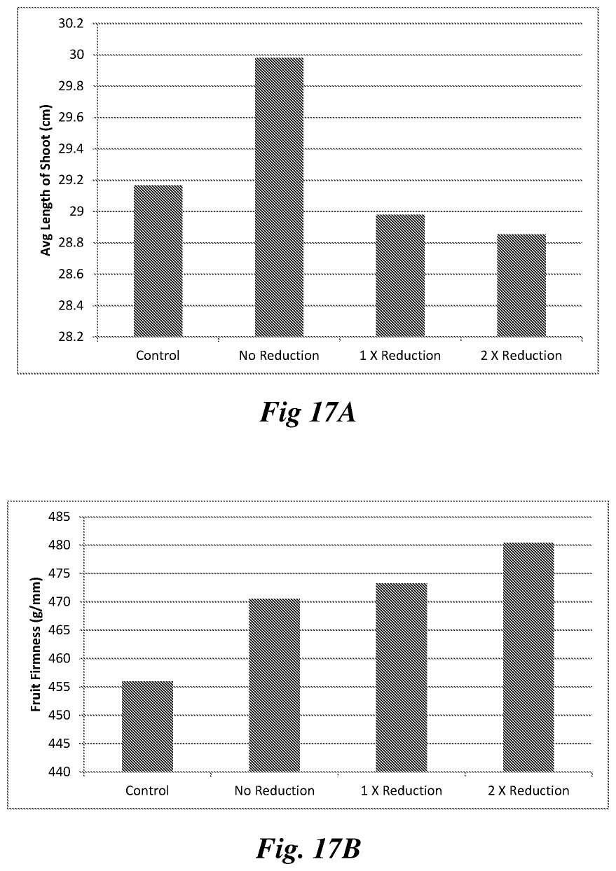

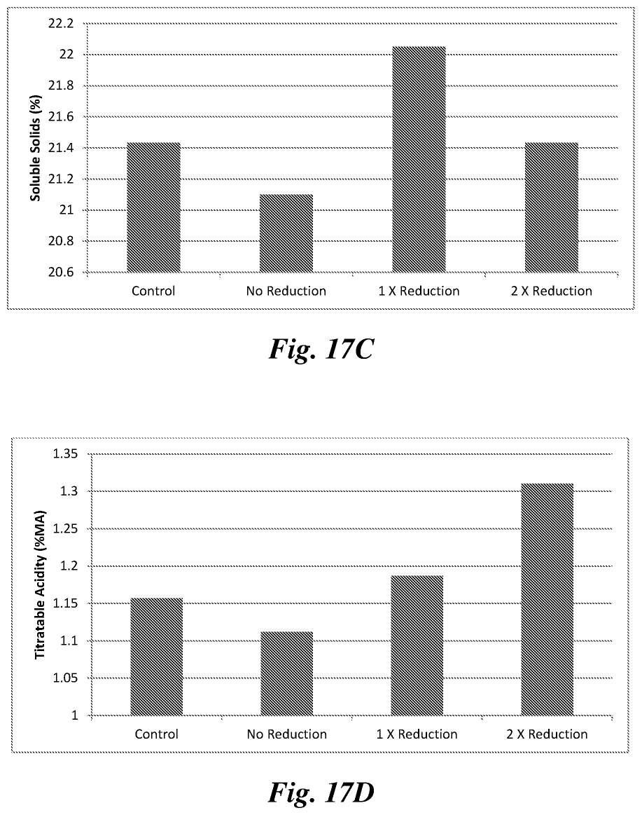

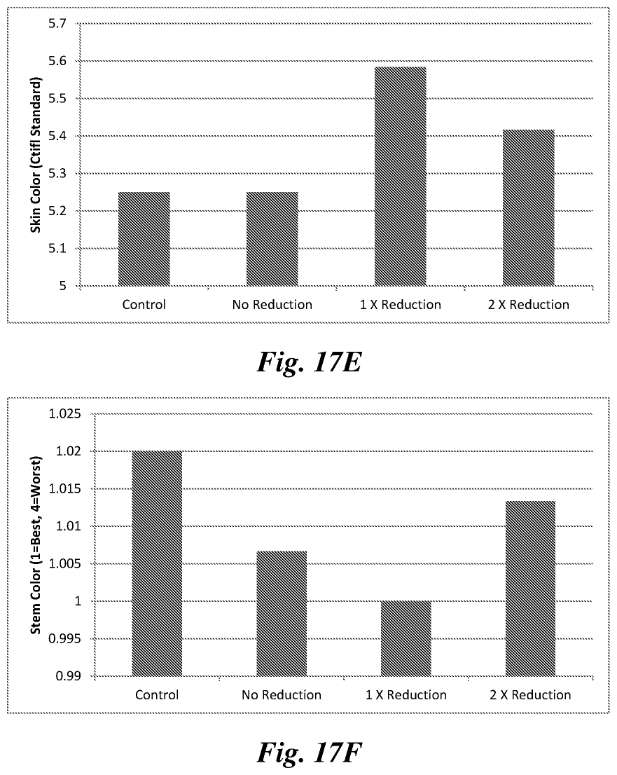

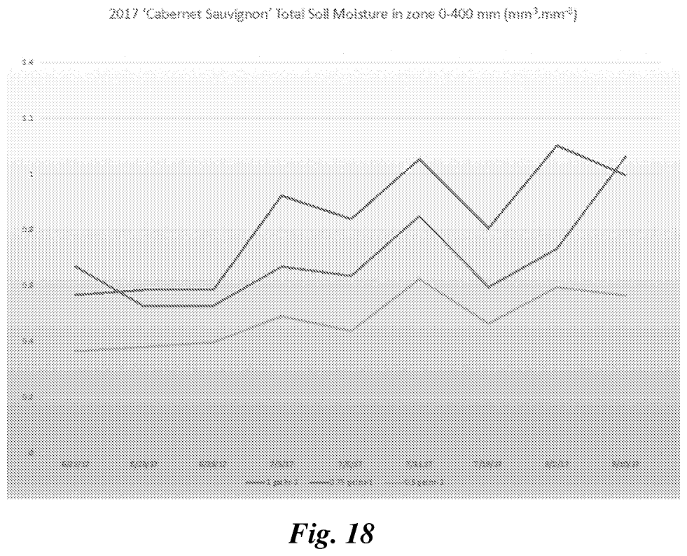

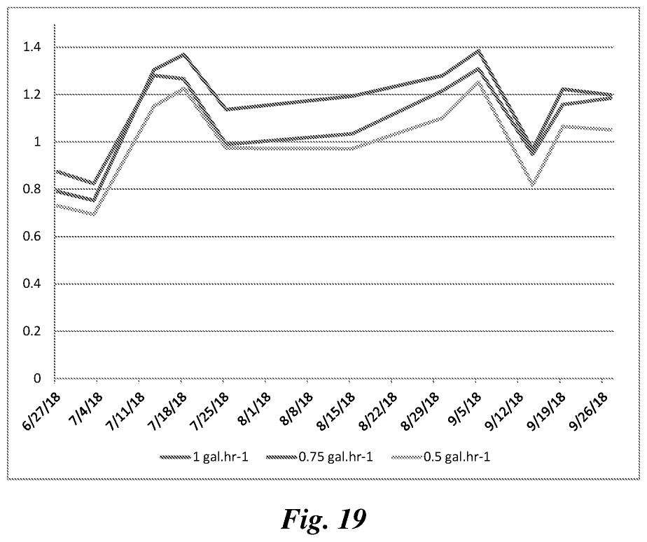

For cherries, when comparing the 13.1% and 31% reductions in irrigation in conjunction with application of 1% exemplary Cuticle Supplement on trees, estimates of yield for individual cherry trees showed no significant differences in yield compared to the untreated check. The results of the experiments are shown in FIGS. 17A-17F.

Fruit quality parameters including TSS, pH, firmness, stem pull force, and skin color showed no significant differences between all treatments and the untreated check. Soil moisture in the 31% reduction began to differ from the 0% and 13.1% reductions as measured by a neutron probe in late July 2018.

1. A plant cuticle supplement, comprising: cellulose fibers in an amount ranging from about 0.001% to about 20% by weight; a swelling component in an amount ranging from about 0.001% to about 15% by weight; and a thickening component in an amount ranging from about 0.001% to about 15% by weight.

2. The plant cuticle supplement of claim 1, wherein the plant cuticle supplement is non-aqueous.

3-4. (canceled)

5. The plant cuticle supplement of claim 1, wherein the plant cuticle supplement further comprises an anti-oxidant component in an amount ranging from about 0.001% to about 15% by weight, a humectant component in an amount ranging from about 0.001% to about 15% by weight, an emollient component in an amount ranging from about 0.001% to about 25% by weight, an amphoteric surfactant component in an amount ranging from about 0.001% to about 15% by weight, an occlusive agent component in an amount ranging from about 0.001% to about 45% by weight, a fragrance component a plasticizer component, a non-ionic surfactant, or a combination thereof.

6. The plant cuticle supplement of claim 1, wherein the plant cuticle supplement further comprises a film enhancing component in an amount ranging from about 0.001% to about 15% by weight.

7. The plant cuticle supplement of claim 1, wherein the plant cuticle supplement comprises a bloom effect-providing component in an amount ranging from about 0.001% to about 15% by weight.

8. The plant cuticle supplement of claim 1, wherein the plant cuticle supplement comprises cellulose fiber, pectin, calcium bentonite, non-ionic surfactant, and amphoteric surfactant.

9. The plant cuticle supplement of claim 1, wherein the plant cuticle supplement comprises ethanol.

10. The plant cuticle supplement of claim 5, wherein the antioxidant component is Vitamin E, ascorbyl palmitate, or ascorbyl stearate.

11. The plant cuticle supplement of claim 5, wherein the humectant component is glycerol.

12. The plant cuticle supplement of claim 5, wherein the emollient component is safflower oil.

13. The plant cuticle supplement of claim 5, wherein the amphoteric surfactant component is lecithin.

14. The plant cuticle supplement of claim 5, wherein the non-ionic surfactant is a silicone surfactant.

15. (canceled)

16. The plant cuticle supplement of claim 5, wherein the bloom effect-providing component is glycerol monostearate.

17-18. (canceled)

19. The plant cuticle supplement of claim 1, wherein upon application of an aqueous solution of the plant cuticle supplement to a plant or a plant part, the plant cuticle supplement forms an exogenous film thereon after drying of the aqueous solution.

20-22. (canceled)

23. An aqueous composition comprising the plant cuticle supplement of claim 1 in an amount ranging from about 0.01% to about 10% by volume.

24. A method of treating a plant or a plant part comprising: contacting the plant or a plant part with the aqueous composition of claim 23, wherein upon drying of the composition an exogenous film is formed on the plant or a plant part.

25-40. (canceled)

41. A method of reducing egg laying of D. suzukii in a plant comprising contacting the plant with the aqueous composition of claim 23, wherein upon drying of the composition an exogenous film is formed on the plant thereby reducing egg laying of D. suzukii in the plant.

42-44. (canceled)

45. The plant cuticle supplement of claim 1, wherein the cellulose fibers are microcrystalline cellulose.

46. The plant cuticle supplement of claim 1, wherein the cellulose fibers have a size of about 0.1 μm to about 150 μm.

47. The plant cuticle supplement of claim 1, wherein the swelling component is hemicellulose or pectin.
